(19) United States
(12) Patent Application Publication
(10) Pub. No.: US 2024/0310848 A1
(43) Pub. Date: Sep. 19, 2024

(54) APPARATUS AND METHOD FOR DETECTING INDOOR ENVIRONMENT USING UNMANNED MOBILE VEHICLE

(71) Applicant: ELECTRONICS AND TELECOMMUNICATIONS RESEARCH INSTITUTE, Daejeon (KR)

(72) Inventors: Ji Hun JEON, Daejeon (KR); Kang Bok LEE, Daejeon (KR); Sang Yeoun LEE, Daejeon (KR); Soo Young JANG, Daejeon (KR); Min Gi Jeong, Daejeon (KR)

(21) Appl. No.: 18/601,829

(22) Filed: Mar. 11, 2024

(30) Foreign Application Priority Data
Mar. 13, 2023 (KR) 10-2023-0032512

(51) Int. Cl. G05D 1/246; G05D 1/622; G05D 107/40; G05D 109/20; G05D 111/10; G05D 111/30; G05D 111/50

(52) U.S. Cl. CPC G05D 1/246; G05D 1/622; G05D 2107/40; G05D 2109/20; G05D 2111/14; G05D 2111/30; G05D 2111/52

(57) ABSTRACT

Provided is a method of operating an unmanned mobile vehicle for detecting an indoor environment. The method according to an embodiment of the present disclosure includes obtaining first motion information using a LiDAR sensor provided on the unmanned mobile vehicle, obtaining second motion information using an inertial sensor provided on the unmanned mobile vehicle, performing correction on the first motion information and the second motion information on the basis of error models corresponding to the LiDAR sensor and the inertial sensor, and determining final position information of the unmanned mobile vehicle on the basis of the correction.

### CROSS-REFERENCE TO RELATED APPLICATION

This application claims priority to and the benefit of Korean Patent Application No. 10-2023-0032512, filed on Mar. 13, 2023, the disclosure of which is incorporated herein by reference in its entirety.

### BACKGROUND

### 1. Field of the Invention

The present disclosure relates to a technology for detecting an indoor environment using an unmanned mobile vehicle, and more specifically, to a technology for generating an overall map of an indoor environment using ultra-wideband (UWB) technology of an unmanned mobile vehicle.

### 2. Discussion of Related Art

In view of position recognition and communication, in order to effectively use unmanned mobile vehicles such as drones, the position of the unmanned mobile vehicle should be accurately recognized and smooth communication between different devices should be possible.

Position recognition refers to the ability of an unmanned mobile vehicle to determine its position relative to a surrounding environment. The position recognition may be achieved through various technologies such as Global Positioning System (GPS), radar, LiDAR, and the like.

Communication between unmanned mobile vehicles is also essential for a successful operation. Accordingly, the unmanned mobile vehicles may share information on position, velocity, and other related data to coordinate their movements, and work together to achieve a common goal. Communication between unmanned mobile vehicles may be achieved through various wireless technologies such as Wi-Fi, Bluetooth, radio frequency (RF) communication, and the like. RF communications are commonly used for long-distance communication between unmanned mobile vehicles because it provides stable and robust connections even in complicated environments.

Position recognition technology is divided into outdoor position recognition and indoor position recognition, and the related art regarding position recognition is as follows.

In the case of outdoor swarm and formation drones, which are representative of unmanned mobile vehicles, drones move to accurate positions and perform swarm and formation flights on the basis of real time kinematic (RTK)-GPS technology that can recognize centimeter-level precise positions in outdoor environments. The RTK-GPS is a technology in which a GPS (GPS Base) may be installed in a position where a latitude, an altitude, and a longitude are known in advance, errors of the GPS received at the known position may be calculated, and then errors may be transmitted to nearby GPS devices (GPS Rover) and corrected. In outdoor swarm flights, in order to utilize RTK-GPS technology, a GPS Base may be installed near a ground station system that directs a position of each drone, and may transmit errors to a GPS equipped on each drone so that the drones can move to exact positions through GPS error correction.

However, since GPS signals cannot be received in indoor environments due to building materials, the indoors becomes a GPS shadow area and thus position recognition through GPS cannot be used. Currently, in order to recognize positions in indoor environments, a method of recognizing positions by attaching markers that reflect infrared rays to a drone and then reading coordinates of the markers using a motion capture system, or a method of recognizing positions by installing special markers on the floor or ceiling and recognizing the markers with images is used.

However, these systems have a disadvantage of requiring pre-installation. A motion capture system has a disadvantage that motion capture cameras should be installed and set up and position recognition is only possible in a space surrounded by the cameras, and a marker-based system has a disadvantage that markers should be attached within a range of recognizing the position. Because of the above disadvantages, indoor swarm and formation flights could only be operated in specific positions where all systems were installed in advance, and operation was not possible in unknown indoor environments where the systems were not pre-installed.

Among the communication technologies for unmanned mobile vehicles, the conventional technologies related to indoor communication are as follows.

In the case of existing outdoor swarm and formation drones, Wi-Fi is used to communicate between a server and drones or between drones. In indoor environments, Wi-Fi signals are absorbed by building materials and reflected by walls and the like, and thus communication between a server and drones or between drones is impossible beyond a certain distance where Wi-Fi signals cannot be detected. For this reason, even when autonomous drones that do not require server-drone communication and human intervention are operated, communication between drones was impossible beyond a certain distance.

In order to compensate for the above disadvantages, research is being conducted on technology for accurately determining positions of unmanned mobile vehicles and communicating between the unmanned mobile vehicles in an indoor environment.

### SUMMARY OF THE INVENTION

The present disclosure is directed to providing a method in which multiple unmanned mobile vehicles can simultaneously search unknown indoor environments using three-dimensional (3D) LiDAR and ultra-wideband (UWB).

In order to enable unmanned mobile vehicles to operate in unknown indoor environments, LiDAR-based position recognition technology, in which expensive sensors are used but which is robust in position recognition and can generate a map of a searched area, is used. The unmanned mobile vehicle generates a local map of its surroundings using position recognition information using LiDAR and point cloud information from LiDAR, and generates a local map with three attributes: a space with no obstacles, a space with obstacles, and a space that has not yet been searched. The unmanned mobile vehicle continues to move to the no searched space among them and conducts indoor search. Surrounding map information generated by each unmanned mobile vehicle is transmitted to each unmanned mobile vehicle using UWB, which can communicate over a wide range in an indoor environment. it is possible to generate an overall global map by integrating local map information generated by each unmanned mobile vehicle with relative position information between the respective unmanned mobile vehicles through relative position recognition using an arrival time of UWB in addition to simply communicating through UWB. Accordingly, each unmanned mobile vehicle is able to know, by other unmanned mobile vehicles, places where search has been conducted and places where search has not yet been conducted, and thus it is possible to efficiently conduct indoor search.

According to an aspect of the present disclosure, there is provided a method of operating an unmanned mobile vehicle for detecting an indoor environment, which includes obtaining first motion information using a LiDAR sensor provided on the unmanned mobile vehicle, obtaining second motion information using an inertial sensor provided on the unmanned mobile vehicle, performing correction on the first motion information and the second motion information on the basis of error models corresponding to the LiDAR sensor and the inertial sensor, and determining final position information of the unmanned mobile vehicle on the basis of the correction.

The obtaining of the first motion information using the LiDAR sensor may further include obtaining first point information on a surrounding environment, in response to the obtaining of the first point information, obtaining second point information on the surrounding environment after a first cycle, and determining motion information corresponding to a minimum error between the first point information and the second point information as the first motion information on the basis of an iterative closest point (ICP) algorithm.

The obtaining of the second motion information using the inertial sensor may further include obtaining one or more pieces of velocity information corresponding to a movement of the unmanned mobile vehicle every second cycle, identifying velocity information corresponding to the first cycle from among the one or more pieces of velocity information, and generating the second motion information on the basis of the velocity information corresponding to the first cycle.

The method may further include obtaining a plurality of pieces of point information using the LiDAR sensor, identifying one or more pieces of point information corresponding to a predetermined height range from among the plurality of pieces of point information on the basis of the final position information, identifying an area to which the one or more pieces of point information belong as an obstacle in a two-dimensional (2D) grid map, and generating a local map on the basis of the 2D grid map and the obstacle.

The method may further include identifying an unsearched area on the basis of the final position information and a position of the obstacle, wherein the identifying of the unsearched area is repeatedly performed according to a change in the final position information.

The identifying of the unsearched area may further include identifying a virtual line connecting the final position information and the position of the obstacle, wherein the unsearched area may include an area that is present on an opposite side of the final position information in a direction of the virtual line.

According to another aspect of the present disclosure, there is provided an apparatus of an unmanned mobile vehicle for detecting an indoor environment, which includes a transmission and reception unit, and at least one control unit operably connected to the transmission and reception unit, wherein the at least one control unit is configured to obtain first motion information using a LiDAR sensor provided on the unmanned mobile vehicle, obtain second motion information using an inertial sensor provided on the unmanned mobile vehicle, perform correction on the first motion information and the second motion information on the basis of error models corresponding to the LiDAR sensor and the inertial sensor, and determine final position information of the unmanned mobile vehicle on the basis of the correction.

In order to obtain the first motion information using the LiDAR sensor, the at least one control unit may be configured to obtain first point information on a surrounding environment, in response to obtaining the first point information, obtain second point information on the surrounding environment after a first cycle, and determine motion information corresponding to a minimum error between the first point information and the second point information as the first motion information on the basis of an ICP algorithm.

In order to obtain the second motion information using the inertial sensor, the at least one control unit may be further configured to obtain one or more pieces of velocity information corresponding to a movement of the unmanned mobile vehicle every second cycle, identify velocity information corresponding to the first cycle from among the one or more pieces of velocity information, and generate the second motion information on the basis of the velocity information corresponding to the first cycle.

The at least one control unit may be further configured to obtain a plurality of pieces of point information using the LiDAR sensor, identify one or more pieces of point information corresponding to a predetermined height range from among the plurality of pieces of point information on the basis of the final position information, identify an area to which the one or more pieces of point information belong as an obstacle in a 2D grid map, and generate a local map on the basis of the 2D grid map and the obstacle.

The at least one control unit may be further configured to identify an unsearched area on the basis of the final position information and a position of the obstacle, and the at least one control unit repeatedly performs the identification of the unsearched area according to a change in the final position information.

In order to identify the unsearched area, the at least one control unit may be further configured to identify a virtual line connecting the final position information and the position of the obstacle, and the unsearched area may include an area that is present on an opposite side of the final position information in a direction of the virtual line.

According to still another aspect of the present disclosure, there is provided a method of operating a system for generating an overall map using an unmanned mobile vehicle, which includes obtaining a plurality of pieces of local map information from a plurality of unmanned mobile vehicles, obtaining pieces of position information on the plurality of unmanned mobile vehicles, determining relative positions for each of the plurality of unmanned mobile vehicles on the basis of the pieces of position information, and generating overall map information on the basis of the relative positions and the plurality of pieces of local map information.

The plurality of pieces of local map information and the position information may be obtained using UWB technology.

The determining of the relative positions for each of the plurality of unmanned mobile vehicles may include determining a time difference corresponding to signal exchange between a first UWB module provided in a first unmanned mobile vehicle among the plurality of unmanned mobile vehicles and a second UWB module provided in a second unmanned mobile vehicle among the plurality of unmanned mobile vehicles.

The first UWB module may include a 1-1 UWB module and a 1-2 UWB module that are provided on opposite sides from each other in the first unmanned mobile vehicle, and the second UWB module includes a 2-1 UWB module and a 2-2 UWB module that are provided on opposite sides from each other in the second unmanned mobile vehicle, and the determining of the relative positions for each of the plurality of unmanned mobile vehicles may further include determining two positions using each UWB module included in the first unmanned mobile vehicle and each UWB module included in the second unmanned mobile vehicle, and determining relative positions of the first unmanned mobile vehicle and the second unmanned mobile vehicle on the basis of the two determined positions.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a flowchart of an operation for an unmanned mobile vehicle to recognize a position using a LiDAR sensor and an inertial sensor according to an embodiment of the present disclosure;

FIG. 2 illustrates an initial two-dimensional (2D) grid map used by an unmanned mobile vehicle to generate a local map according to an embodiment of the present disclosure;

FIG. 3 shows surrounding environment information from which point information corresponding to the floor and ceiling around an unmanned mobile vehicle has been removed, according to an embodiment of the present disclosure;

FIG. 4 shows surrounding environment information of an unmanned mobile vehicle expressed by as a 2D grid map according to an embodiment of the present disclosure;

FIG. 5 shows an operation for an unmanned mobile vehicle to determine an unsearched area from among surrounding environment information expressed as a 2D grid map according to an embodiment of the present disclosure;

FIG. 6 shows an arrangement of ultra-wideband (UWB) modules applied to an unmanned mobile vehicle according to an embodiment of the present disclosure;

FIG. 7 is a configuration diagram for obtaining position information between unmanned mobile vehicles in a system according to an embodiment of the present disclosure;

FIG. 8 is a configuration diagram illustrating a method of estimating a relative position using two pieces of position information obtained from a UWB signals in a system according to an embodiment of the present disclosure;

FIG. 9 shows an operation in which a system according to an embodiment of the present disclosure integrates local maps into an overall map on the basis of relative position information between unmanned mobile vehicles; and

FIG. 10 is a flowchart of an operation of an unmanned mobile vehicle according to an embodiment of the present disclosure.

### p DETAILED DESCRIPTION OF EXEMPLARY EMBODIMENTS

Phrases such as “in some embodiments” and “in one embodiment” that appear in various places in this specification do not necessarily both refer to the same embodiment.

Some embodiments of the present disclosure may be represented by functional block components and various processing operations. Some or all of these functional blocks may be implemented in a variety of numbers of hardware and/or software components that perform specific functions. For example, functional blocks of the present disclosure may be implemented by one or more microprocessors, or may be implemented by circuit configurations for a predetermined function. Further, for example, the functional blocks of the present disclosure may be implemented in various programming or scripting languages. The functional blocks may be implemented as an algorithm running on one or more processors. Further, the present disclosure may employ conventional techniques for electronic environment setting, signal processing, and/or data processing. Terms such as “mechanism,” “element,” “means,” and “configuration” may be used broadly and are not limited to mechanical and physical components.

Further, connection lines or connection members between components illustrated in the accompanying drawings are merely examples of functional connections and/or physical or circuit connections. In an actual apparatus, connections between components may be represented by various replaceable or additional functional connections, physical connections, or circuit connections.

Various studies are being conducted to obtain accurate position information in indoor environments using unmanned mobile vehicles and generate an overall map on the basis of the obtained position information.

To this end, as described above, a technology for recognizing an exact position of each of a plurality of unmanned mobile vehicles operating in an indoor environment and transmitting or receiving the recognized position to or from the other unmanned mobile vehicles or an external device (e.g., anchor) is important.

The present disclosure provides novel technologies for solving the above-described problems related to position recognition and communication technology of unmanned mobile vehicles.

First, a technology for recognizing positions of unmanned mobile vehicles in an indoor environment according to an embodiment of the present disclosure will be described as follows.

Latest technologies that enable position recognition in unknown indoor environments without prior installation include visual-inertial-based position recognition (visual-Inertial odometry) and LiDAR-inertial-based position recognition (LiDAR Inertial odometry).

Inertial-based position recognition is a technology for estimating movement and posture changes by integrating information obtained from inertial sensors, such as accelerometers and angular velocimeters, over time, and when a subject is stopped or a velocity of the subject is slow, errors occur due to noise generated from measurement values of the sensor, resulting in large errors over time. Image-based position recognition is a technology for estimating movement and posture changes between frames by comparing consecutive camera images, and it is suitable for stationary or slow situations, but when the velocity is high and afterimages occur in camera images, errors may occur. Visual-inertial-based position recognition is a combination of the two position recognition technologies, and is a technology for recognizing more accurate positions by correcting errors occurring in the inertial sensor estimation with the image-based position recognition.

LiDAR-based position recognition is a technology for recognizing positions by comparing point cloud point groups continuously obtained from two-dimensional (2D)/three-dimensional (3D) LIDAR by cycle, just as camera images are compared for each frame in image-based position recognition, to estimate movement and posture changes and accumulate results of the estimation so as to minimize errors with existing point clouds. In LiDAR-based position recognition, more accurate positions may be obtained through a LiDAR-inertial-based position recognition technology combined with inertial-based position recognition.

Further, a communication technology for an unmanned mobile vehicle according to an embodiment of the present disclosure to transmit or receive signals or data to or from another unmanned mobile vehicle or another device will be described as follows.

Ultra-wideband (UWB) is a method of transmitting radio signals with a wide frequency band, and is a promising technology in the fields of indoor communication and position recognition because it has stronger resistance to multi-signal errors than Bluetooth or Wi-Fi and can penetrate building materials to some extent.

In UWB, a method of calculating a distance between devices by measuring a difference between a time at which radio waves are emitted from a radio wave transmitter of one device and a time at which the radio waves are detected by a radio wave receiver of another device is called a time of arrival (ToA). In UWB, generally, a two-way ToA method is used to calculate a distance between two nodes using a time difference at which a signal is transmitted and received therebetween.

As a position acquisition algorithm using UWB, a method in which anchor nodes at places whose locations are known are fixed, relative distances between a moving node and the fixed anchors are obtained, then circles are drawn, and a position is obtained using a point where the circles overlap is used.

UWB, which can obtain relative distance between nodes even in indoor spaces by penetrating building materials with a wide frequency band, has recently emerged as a suitable communication and positioning method in indoor disaster environments, but since the existing distance recognition method using UWB is a method of installing three or more fixed anchors whose positions are known and determining a position of a moving node through the fixed anchors, pre-installation may be required.

The present disclosure relates to a technology for generating an overall map corresponding to an indoor environment by combining a position recognition technology using both a LiDAR sensor and an inertial sensor and a UWB-based communication technology.

First, an unmanned mobile vehicle according to an embodiment of the present disclosure may obtain accurate position information on itself and its surrounding environment by adaptively using a LiDAR sensor and an inertial sensor, and generate a local map on the basis of the obtained position information.

Since one unmanned mobile vehicle generates a local map of the surrounding environment detected based on itself, in a system in which a plurality of unmanned mobile vehicles are present, one overall map may be generated by integrating a plurality of local maps corresponding to each unmanned mobile vehicle. In order to integrate the respective local maps, relative positions of the respective unmanned mobile vehicles may be considered, and the relative positions may be obtained or processed using UWB technology.

These technical features will be described in more detail by being divided into three categories.

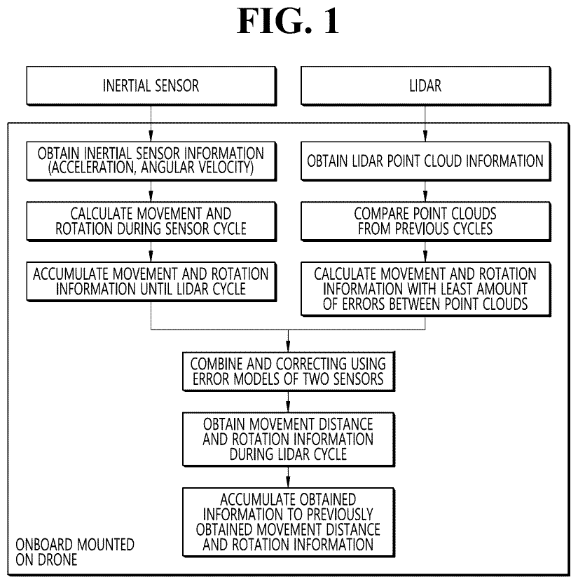

FIG. 1 is a flowchart of an operation for an unmanned mobile vehicle to recognize a position using a LiDAR sensor and an inertial sensor according to an embodiment of the present disclosure.

Referring to FIG. 1, the unmanned mobile vehicle may perform position recognition using a LiDAR sensor and position recognition using an inertial sensor in parallel, and then adaptively reflect each piece of result information.

When the LiDAR sensor transmits point cloud information measured about a surrounding environment to a board mounted on the unmanned mobile vehicle, the board calculates how much the unmanned mobile vehicle moves and rotates between a previous cycle and this cycle using an iterative closest point (ICP) algorithm for calculating movement and rotation information with the least amount of errors between a point group received in a previous cycle and a point group received in this cycle.

Specifically, the ICP algorithm is an algorithm used in the fields of robotics, computer vision, and computer graphics to align two point clouds by finding a rigorous transformation (i.e., transformation and rotation) that maps one point cloud.

In the context of recognizing a position of an unmanned mobile vehicle through a LiDAR sensor, the ICP algorithm may be used to align a LiDAR scan of a current pose with a previously known environment map, which is represented as a point cloud.

The ICP algorithm may operate by first selecting a set of correspondences between a LiDAR scan point and a point on a map. This correspondence may be generally established by finding the closest point on the map to each point in the LiDAR scan. When the correspondence is established, the algorithm may iteratively calculate a rigorous transformation that best aligns two point clouds. The transformation may be calculated by minimizing the sum of squares of a distance between corresponding points in two point clouds.

The ICP algorithm may generally minimize the sum of squares of a distance using a variation of the Gauss-Newton optimization method. At each iteration, the algorithm may calculate a Jacobian matrix of an error function with respect to parameters of the rigorous transformation (i.e., transformation and rotation) and use the calculated Jacobian matrix to update the transformation estimate.

The ICP algorithm may continue iterations until a stopping condition is met, such as a maximum number of iterations or a threshold value for a change in the error function. The final estimate of the transformation may be used to update the posture of the unmanned mobile vehicle.

Similarly, in inertial sensors, movement distance and rotation information may be calculated through acceleration and angular velocity information during a cycle of the sensor.

A process in which an unmanned mobile vehicle recognizes a position using an inertial sensor will be described as follows.

The unmanned mobile vehicle may first measure an acceleration. An accelerometer provided in the unmanned mobile vehicle may measure three dimensionally an acceleration of the unmanned mobile vehicle. Such measurement is generally affected by various noise sources, such as vibration and gravity, and may be made more accurately by filtering and compensating for bias and other errors.

The unmanned mobile vehicle may measure an angular velocity. A gyroscope provided in the unmanned mobile vehicle may measure three dimensionally an angular velocity of the unmanned mobile vehicle. Such measurement is affected by noise, such as drift and bias, and errors, and may be made more accurately through correction and filtering to obtain accurate readings.

The unmanned mobile vehicle may integrate the measured acceleration and angular velocity. That is, the unmanned mobile vehicle may integrate the acceleration and the angular velocity to estimate the vehicle's position, velocity, and orientation over time. This integration process may include numerically integrating the equations of motion, such as the equation of motion for position and velocity and the Euler equation for direction.

Since the estimated position, velocity, and orientation obtained by the integration process may be affected by various error sources such as drift, bias, and noise, the unmanned mobile vehicle may combine values that are measured using a sensor integration algorithm with other sensor data, such as Global Positioning System (GPS), LiDAR, or camera data in order to correct these errors.

An operation in which the unmanned mobile vehicle measures the acceleration or the angular velocity may be performed periodically. Usually, since the cycle of an inertial sensor is much faster than that of a lidar, the inertial sensor may continue to accumulate calculation results for movement and rotation information for each cycle of the inertial sensor until calculation results during the cycle of the LiDAR sensor are available.

When the calculation results of the LiDAR sensor are output, correction is performed to minimize errors on the basis of error models corresponding to the inertial sensor and LiDAR sensor. By adding the movement distance and rotation results during the cycle of the LiDAR sensor that are obtained through the correction to the movement distance and rotation information that is obtained before starting the calculation, position recognition results based on LiDAR and inertial sensors may be obtained.

The unmanned mobile vehicle according to the embodiment of the present disclosure may generate a local map for obstacle avoidance and search.

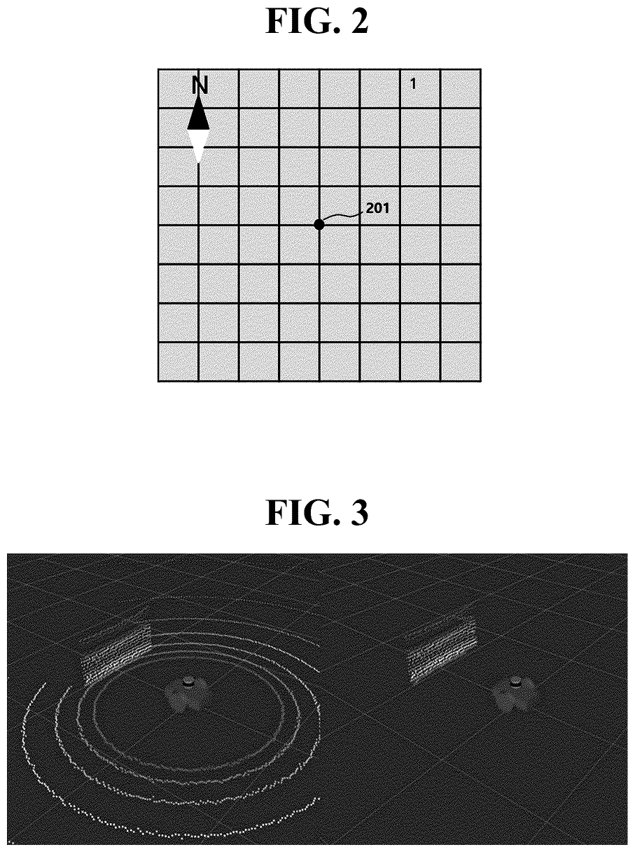

FIG. 2 illustrates an initial 2D grid map used by an unmanned mobile vehicle to generate a local map according to an embodiment of the present disclosure.

A local map generation technology for searching for the surroundings of each unmanned mobile vehicle and allowing the unmanned mobile vehicle to move while avoiding obstacles is as follows. First, a 2D grid map in the form of a top view with a current position 201 of the unmanned mobile vehicle at the center and facing true north upward may be generated. In this case, a spacing between grids in a grid map varies depending on the degree to which the surrounding environment is intended to be expressed in detail. Each grid value in the generated grid map may be displayed as default 1 (unsearched). The reason for generating the grid map may be to simplify the map to make calculations faster and easier to integrate.

FIG. 3 shows surrounding environment information from which point information corresponding to the floor and ceiling around an unmanned mobile vehicle has been removed, according to an embodiment of the present disclosure.

The unmanned mobile vehicle may obtain 3D point information related to a surrounding environment using a LiDAR sensor. There may be a plurality of pieces of point information. The unmanned mobile vehicle may analyze the plurality of pieces of point information to identify point information corresponding to at least one of the floor or the ceiling of the surrounding environment.

Specifically, the unmanned mobile vehicle may measure the plurality of pieces of point information from the floor area and remove the point information above or below a certain height using height information among the pieces of position information of the unmanned mobile vehicle.

For example, when the LiDAR sensor obtains 250 pieces of point information, the unmanned mobile vehicle may identify the floor area from the 250 pieces of point information and determine a critical height for the identified floor area to be 3 meters. Thereafter, the unmanned mobile vehicle may remove 120 pieces of point information corresponding to 3 meters or more and 3 meters or less from the 250 pieces of point information.

Thereafter, the unmanned mobile vehicle may remove a height value attribute from the point information remaining after removing the ceiling and the floor to make the 3D point information two-dimensional.

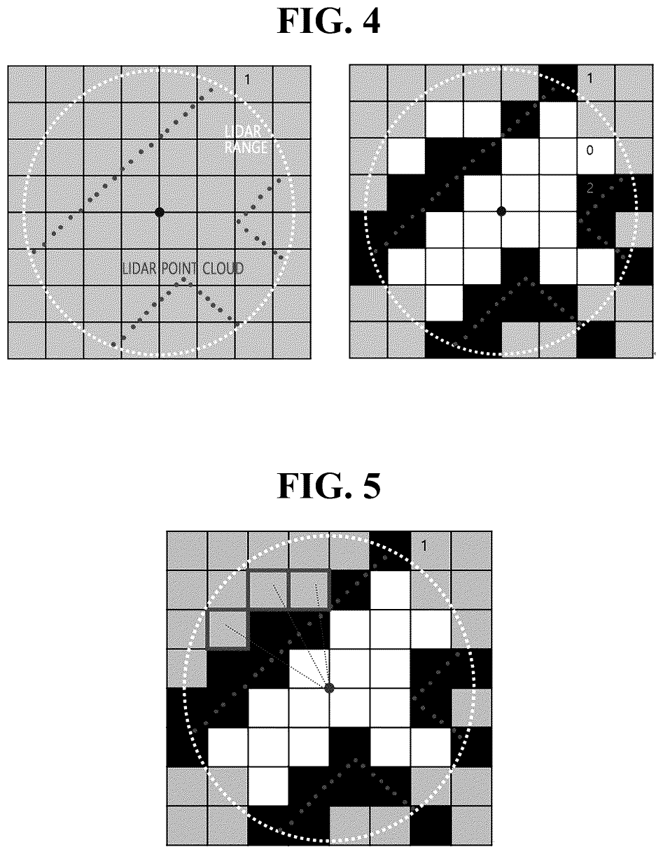

FIG. 4 shows surrounding environment information of an unmanned mobile vehicle expressed by as a 2D grid map according to an embodiment of the present disclosure.

The unmanned mobile vehicle may compare pieces of 2D point information with the 2D grid map, and when there is no LiDAR point information in the grids included all within a LiDAR range, the grids are recorded as 0 (empty space). Even when all grids are not included within the LiDAR range, grids in which point information is present may be recorded as 2 (obstacle).

The above-described recorded values, 0 and 2, are examples of arbitrary values, and the unmanned mobile vehicle may apply various indicators to distinguish between empty space and obstacles.

FIG. 5 shows an operation for an unmanned mobile vehicle to determine an unsearched area from among surrounding environment information expressed as a 2D grid map according to an embodiment of the present disclosure.

Due to the characteristics of LIDAR that uses light, when there is an obstacle in front, a rear part may not be measured. Therefore, the unmanned mobile vehicle may record a grid, which is an empty space that is present on a straight line extending from a point group and a current position among grids within a LiDAR range, as 1, indicating an unsearched area.

Thereafter, the unmanned mobile vehicle may repeat the above process to generate a local map while moving the position of the unmanned mobile vehicle within the grid according to results of position recognition based on LiDAR and inertial sensors.

A system including the unmanned mobile vehicle according to the embodiment of the present disclosure may generate an overall map by integrating local maps generated by a plurality of unmanned mobile vehicles.

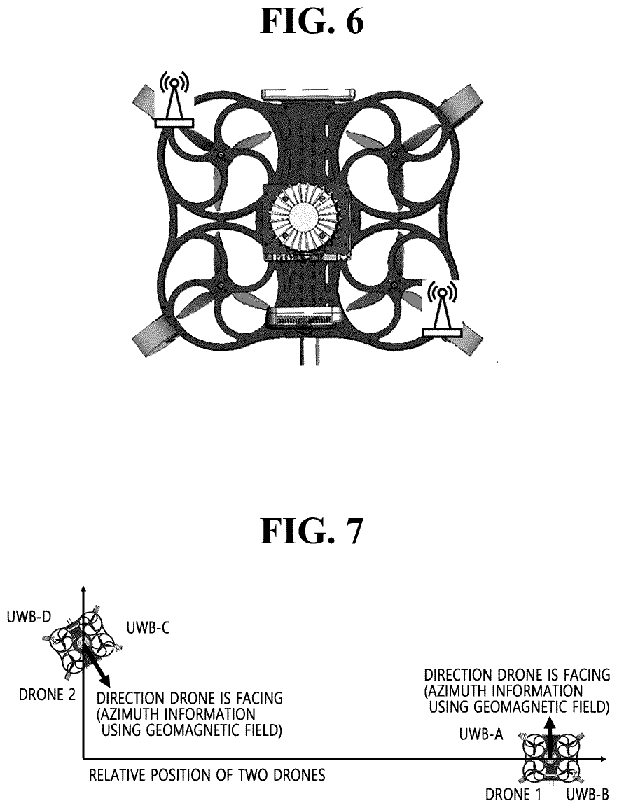

FIG. 6 shows an arrangement of UWB modules applied to an unmanned mobile vehicle according to an embodiment of the present disclosure.

In order to transmit radio signals with a wide frequency band in an indoor environment where infrastructure is not installed, the unmanned mobile vehicle may use UWB-based communication, which has strong resistance to multiple-signal errors and may penetrate building materials to some extent. Further, relative positions of the unmanned mobile vehicles that are separated from each other in the indoor environment may be obtained using arrival intervals of radio wave with UWB.

For example, when the unmanned mobile vehicle is a drone, two UWB modules may be installed diagonally so that the two UWB modules may be positioned furthest from each other. This configuration may be an attempt to reduce errors by maximizing the distance between the UWB modules serving as anchors.

FIG. 7 is a configuration diagram for obtaining position information between unmanned mobile vehicles in a system according to an embodiment of the present disclosure.

Descriptions may be made assuming an environment in which two UWB modules are installed in an unmanned mobile vehicle (e.g., a drone) as shown in FIG. 6.

The unmanned mobile vehicle may obtain distances between UWB modules of two drones that are separated from each other in a two-way ToA method commonly used in UWB that calculates a distance between two nodes on the basis of a time difference at which a signal is transmitted and received therebetween.

Referring to FIG. 7, based on azimuth information obtained using a geomagnetic field, information on a direction the drone is facing may be identified and a distance between the drones may be obtained from UWB signals.

Specifically, its own orientation may be determined by comparing readings of several magnetometers placed in different parts of the drone, and thus a moving direction of the drone may be determined. Further, the UWB signals may be transmitted between two drones and a time it takes for the signals to be moved between the two drones may be measured using a precise clock. By comparing times at which the UWB signals arrive at the two drones, a distance between the two drones may be calculated using a speed of light. Relative positions of the two drones may then be calculated based on their respective positions and the calculated distance between the two drones.

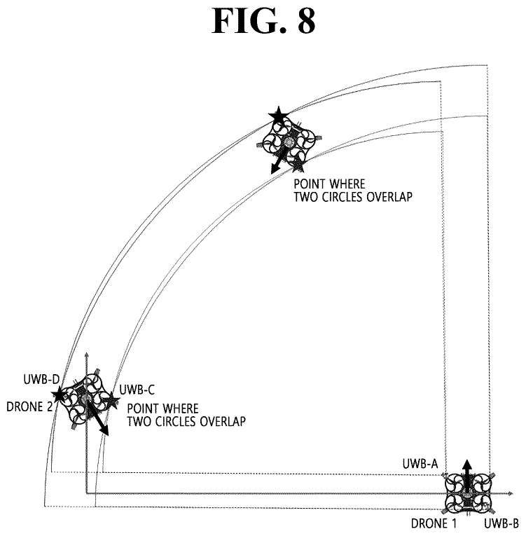

FIG. 8 is a configuration diagram illustrating a method of estimating a relative position using two pieces of position information obtained from a UWB signals in a system according to an embodiment of the present disclosure.

Referring to FIG. 8, a virtual circle may be drawn based on distances obtained through UWB from two UWB modules A and B of Drone 1 to UWB modules C and D of Drone 2. Thereafter, two solutions in which two circles drawn with the distances from the UWB modules A and B to the UWB module C overlap, and two solutions in which two circles drawn with the distances from the UWB modules A and B to the UWB module D overlap may be obtained. Since two positions of each of the UWB modules C and D are identified and the positions of the UWB modules C and D above Drone 2 are known, two positions and orientations of Drone 2 may be estimated by comparing distances between the UWB modules C and D.

Thereafter, through azimuth information of each drone obtained using a geomagnetic field in an inertial sensor, a difference in angle between the two drones may be obtained to determine which of the two solutions is a true value. Accordingly, the relative positions of the two drones may be obtained.

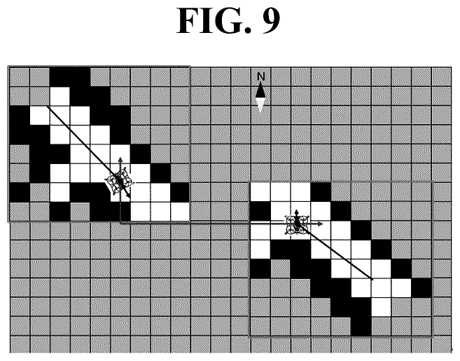

FIG. 9 shows an operation in which a system according to an embodiment of the present disclosure integrates local maps into an overall map on the basis of relative position information between unmanned mobile vehicles.

After obtaining the relative positions of the two unmanned mobile vehicles, the local maps generated by each of the two unmanned mobile vehicles may be integrated into one overall map using the relative positions.

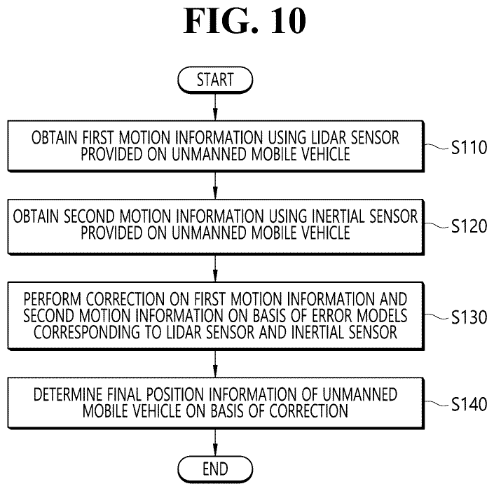

FIG. 10 is a flowchart of an operation of an unmanned mobile vehicle according to an embodiment of the present disclosure.

In operation S110, the unmanned mobile vehicle obtains first motion information using a LiDAR sensor.

Specifically, the unmanned mobile vehicle may further perform an operation of obtaining the first point information on a surrounding environment, obtaining second point information on the surrounding environment after a first cycle in response to the obtaining of the first point information, and determining, as the first motion information, motion information corresponding to a minimum error between the first point information and the second point information, on the basis of an ICP algorithm.

In operation S120, the unmanned mobile vehicle obtains second motion information using an inertial sensor.

Specifically, the unmanned mobile vehicle may further perform an operation of obtaining one or more pieces of velocity information corresponding to the movement every second cycle, identifying velocity information corresponding to the first cycle among the one or more pieces of velocity information, and generating the second motion information on the basis of the velocity information corresponding to the first cycle.

In operation S130, the unmanned mobile vehicle performs correction on the first motion information and the second motion information on the basis of error models corresponding to the LiDAR sensor and the inertial sensor.

The above process may be referred to as a correction process. In the correction process, the unmanned mobile vehicle may analyze the obtained first motion information and second motion information to identify a bias or an error in readings of the sensor. This analysis may include comparing readings from other sensors or comparing readings to known values.

Thereafter, the unmanned mobile vehicle may estimate correction parameters. The first and second motion information may be used to estimate correction parameters that are required to correct the identified bias or error. These parameters may include correction factors, offsets, and scaling factors. Thereafter, the unmanned mobile vehicle may apply the correction parameters. Specifically, the estimated correction parameters may be applied to sensor data to modify the identified bias or the error. Thereafter, the unmanned mobile vehicle may verify the correction by applying the correction parameters, collecting the motion information, and checking whether the modified sensor data accurately represents a position and orientation of the unmanned mobile vehicle.

In operation S140, the unmanned mobile vehicle determines final position information of the unmanned mobile vehicle on the basis of the correction.

Thereafter, the unmanned mobile vehicle may further perform an operation of obtaining a plurality of pieces of point information using the LiDAR sensor, identifying one or more pieces of point information corresponding to a predetermined height range on the basis of the final position information from among the plurality of pieces of point information, identifying an area to which the one or more pieces of point information belongs as an obstacle in a 2D grid map, and generating a local map on the basis of the 2D grid map and the obstacle.

Thereafter, the unmanned mobile vehicle may further perform an operation of identifying an unsearched area on the basis of the final position information and a position of the obstacle, and may repeat the operation according to changes in the final position information.

Further, the unmanned mobile vehicle may further perform an operation of identifying a virtual line connecting the final position information and the position of the obstacle. In this case, the unsearched area may be an area that is present on an opposite side of the final position information in a direction of the virtual line.

The embodiments of the present disclosure described above are not only implemented through devices and methods, but may also be implemented through programs that implement functions corresponding to the configurations of the embodiments of the present disclosure or recording media on which the programs are recorded.

According to the present disclosure, there are advantages in that in unknown indoor environments, an unmanned mobile vehicle that cannot be operated indoors can be operated, by generating a local map, an unmanned mobile vehicle can recognize obstacles in an indoor environment that need to be avoided, and move to and search for a place with no obstacles, by applying UWB communication between unmanned mobile vehicles that have difficulty communicating when the unmanned mobile vehicles are separated from each other in an indoor environment, the unmanned mobile vehicles can communicate with each other even in the indoor environment, instead of using a UWB indoor positioning method, which requires position recognition by installing UWB to act as an anchor, by installing two UWB modules in each unmanned mobile vehicle, it is possible to obtain relative positions of moving unmanned mobile vehicles through azimuth information using a geomagnetic field, an overall global map can be generated using the obtained relative position, through the overall global map, it is possible to search indoors faster than a single unmanned mobile vehicle, and it is possible to efficiently search indoor environment because positions that other unmanned mobile vehicles have already searched can be known.

While embodiments of the present disclosure have been described above in detail, the scope of embodiments of the present disclosure is not limited thereto and encompasses several modifications and improvements by those skilled in the art using the basic concepts of embodiments of the present disclosure defined by the appended claims.

The above-described contents are specific embodiments for embodying the present disclosure. The present disclosure includes not only the above-described embodiments, but also embodiments that are simply designed or can be easily changed. Further, the present disclosure also includes techniques that can be easily modified and implemented using the embodiments. Therefore, the scope of the present disclosure is defined not by the above-described embodiment but by the appended claims, and encompasses equivalents that fall within the scope of the appended claims.

What is claimed is:

1. A method of operating an unmanned mobile vehicle for detecting an indoor environment, comprising:
obtaining first motion information using a LiDAR sensor provided on the unmanned mobile vehicle;
obtaining second motion information using an inertial sensor provided on the unmanned mobile vehicle;
performing correction on the first motion information and the second motion information on the basis of error models corresponding to the LiDAR sensor and the inertial sensor; and
determining final position information of the unmanned mobile vehicle on the basis of the correction.

2. The method of claim 1, wherein the obtaining of the first motion information using the LiDAR sensor further includes:
obtaining first point information on a surrounding environment;
in response to the obtaining of the first point information, obtaining second point information on the surrounding environment after a first cycle; and
determining motion information corresponding to a minimum error between the first point information and the second point information as the first motion information on the basis of an iterative closest point (ICP) algorithm.

3. The method of claim 2, wherein the obtaining of the second motion information using the inertial sensor further includes:
obtaining one or more pieces of velocity information corresponding to a movement of the unmanned mobile vehicle every second cycle;
identifying velocity information corresponding to the first cycle from among the one or more pieces of velocity information; and
generating the second motion information on the basis of the velocity information corresponding to the first cycle.

4. The method of claim 1, further comprising:
obtaining a plurality of pieces of point information using the LiDAR sensor;
identifying one or more pieces of point information corresponding to a predetermined height range from among the plurality of pieces of point information on the basis of the final position information;
identifying an area to which the one or more pieces of point information belong as an obstacle in a two-dimensional (2D) grid map; and
generating a local map on the basis of the 2D grid map and the obstacle.

5. The method of claim 4, further comprising identifying an unsearched area on the basis of the final position information and a position of the obstacle,
wherein the identifying of the unsearched area is repeatedly performed according to a change in the final position information.

6. The method of claim 5, wherein the identifying of the unsearched area further includes identifying a virtual line connecting the final position information and the position of the obstacle, and
the unsearched area includes an area that is present on an opposite side of the final position information in a direction of the virtual line.

7. An apparatus of an unmanned mobile vehicle for detecting an indoor environment, comprising:
a transmission and reception unit; and
at least one control unit operably connected to the transmission and reception unit,
wherein the at least one control unit is configured to obtain first motion information using a LiDAR sensor provided on the unmanned mobile vehicle,
obtain second motion information using an inertial sensor provided on the unmanned mobile vehicle,
perform correction on the first motion information and the second motion information on the basis of error models corresponding to the LiDAR sensor and the inertial sensor, and
determine final position information of the unmanned mobile vehicle on the basis of the correction.

8. The apparatus of claim 7, wherein, in order to obtain the first motion information using the LiDAR sensor, the at least one control unit is further configured to obtain first point information on a surrounding environment,
in response to obtaining the first point information, obtain second point information on the surrounding environment after a first cycle, and
determine motion information corresponding to a minimum error between the first point information and the second point information as the first motion information on the basis of an iterative closest point (ICP) algorithm.

9. The apparatus of claim 8, wherein, in order to obtain the second motion information using the inertial sensor, the at least one control unit is further configured to obtain one or more pieces of velocity information corresponding to a movement of the unmanned mobile vehicle every second cycle,
identify velocity information corresponding to the first cycle from among the one or more pieces of velocity information, and
generate the second motion information on the basis of the velocity information corresponding to the first cycle.

10. The apparatus of claim 7, wherein the at least one control unit is further configured to obtain a plurality of pieces of point information using the LiDAR sensor,
identify one or more pieces of point information corresponding to a predetermined height range from among the plurality of pieces of point information on the basis of the final position information,
identify an area to which the one or more pieces of point information belong as an obstacle in a two-dimensional (2D) grid map, and
generate a local map on the basis of the 2D grid map and the obstacle.

11. The apparatus of claim 10, wherein the at least one control unit is further configured to identify an unsearched area on the basis of the final position information and a position of the obstacle, and
the at least one control unit repeatedly performs the identification of the unsearched area according to a change in the final position information.

12. The apparatus of claim 11, wherein, in order to identify the unsearched area, the at least one control unit is further configured to identify a virtual line connecting the final position information and the position of the obstacle, and
the unsearched area includes an area that is present on an opposite side of the final position information in a direction of the virtual line.

13. A method of operating a system for generating an overall map using an unmanned mobile vehicle, comprising:
obtaining a plurality of pieces of local map information from a plurality of unmanned mobile vehicles;
obtaining pieces of position information on the plurality of unmanned mobile vehicles;
determining relative positions for each of the plurality of unmanned mobile vehicles on the basis of the pieces of position information; and
generating overall map information on the basis of the relative positions and the plurality of pieces of local map information.

14. The method of claim 13, wherein the plurality of pieces of local map information and the pieces of position information are obtained using ultra-wideband (UWB) technology.

15. The method of claim 14, wherein the determining of the relative positions for each of the plurality of unmanned mobile vehicles includes determining a time difference corresponding to signal exchange between a first UWB module provided in a first unmanned mobile vehicle among the plurality of unmanned mobile vehicles and a second UWB module provided in a second unmanned mobile vehicle among the plurality of unmanned mobile vehicles.

16. The method of claim 15, wherein the first UWB module includes a 1-1 UWB module and a 1-2 UWB module that are provided on opposite sides from each other in the first unmanned mobile vehicle, and the second UWB module includes a 2-1 UWB module and a 2-2 UWB module that are provided on opposite sides from each other in the second unmanned mobile vehicle, and
the determining of the relative positions for each of the plurality of unmanned mobile vehicles further includes:
determining two positions using each UWB module included in the first unmanned mobile vehicle and each UWB module included in the second unmanned mobile vehicle; and
determining relative positions of the first unmanned mobile vehicle and the second unmanned mobile vehicle on the basis of the two determined positions.
